(19) United States
(12) Patent Application Publication
(10) Pub. No.: US 2011/0087555 A1
(43) Pub. Date: Apr. 14, 2011

(54) Computer Implemented Continuous Dual Auction System

(76) Inventor: Jeffrey Brian Gray, West Palm Beach, FL (US)

(21) Appl. No.: 12/902,872

(22) Filed: Oct. 12, 2010

Related U.S. Application Data
(60) Provisional application No. 61/250,582, filed on Oct. 12, 2009.

(51) Int. Cl. G06Q 30/00

(52) U.S. Cl. 705/26.3

(57) ABSTRACT

A computer implemented continuous dual auction system consisting of a computer, server, and a process for creating a real-time online marketplace for the sale of goods and services. The process includes the input of information from a seller about a certain good or service for sale, including but not limited to a price desired and a price the seller is willing to accept. The process also includes the input of information from a buyer about a certain good or service desired, including but not limited to a price a buyer is willing to pay and the highest price a buyer is willing to pay for such a good or service. The process also requires the input of credit card information for validation and guaranty purposes in allowing the buyer and seller to post a bid or offer, respectively, into the continuous dual auction system's real-time online marketplace.

### RELATED APPLICATIONS

This application claims priority to U.S. Provisional Application Ser. No. 61/250,582 filed with the United States Patent and Trademark Office on Oct. 12, 2009 and incorporated herein by reference in its entirety.

### FIELD OF THE INVENTION

The invention generally relates to a computer implemented continuous dual auction system. More specifically, the invention is a computer implemented continuous dual auction system, including a computer, server, database, real-time online marketplace website, and process for the creation of an online marketplace for the selling and buying of goods and services, including but not limited to event tickets.

### BACKGROUND

In an effort to meet the growing demand of electronic shopping, virtual online marketplaces have been setup providing a website to host these online marketplaces for the sale and purchase of goods and services. Companies may use computers, servers and related electronic equipment to setup and maintain databases that are accessed by the public through electronic transmission lines and the public's own computer, personal digital assistant a/k/a a PDA, or other electronic device. Such access is performed through the transmission of data between the public computer and the company's website, for example. There are several ways of connectivity that are available to the public, for instance the public may use a PDA and wireless local area network to access the company's website. Traditionally, the most common types of online auctions used are forward auctions, reverse auctions, Dutch auctions, French auctions, Vickrey auctions, and uniform second price auctions.

In forward auctions, buyers submit competing bids for one product and only one buyer can win once the auction ends. In this type of auction, the price starts low with the bidders increasing their bids at certain intervals and within a predetermined amount. This type of auction favors the seller as the auction tends to move up the price.

In a reverse auction, sellers compete for the buyer's bid. A buyer will post a bid for a given service or product, and the sellers will compete to win the bid. This type of auction is beneficial to the buyer as the transaction price is usually lower than the seller would have normally considered. However, because different buyers are not competing against each other for the seller's good or service, there is no fair competition for the good or service because a true market price for the same is not obtained.

In a Dutch auction, the auctioneer announces a price for a particular good or service. The price falls in equal increments until a bid is created from the market. Buyers tend to second guess whether the price would have fallen further than it did, thus the inability to be aware of the other bids in the marketplace deter actual fair market prices.

In a French auction, all of the buyers' bids and sellers' offers are submitted to the auctioneer in confidence. The auctioneer than decides where to open the auction based on these confidences to create the fair price for the particular product/service. These types of auctions are mainly used for the opening of an auction.

In a Vickrey auction, buyers submit bids in confidence to the auctioneer. After collection of all bids, the auctioneer notifies the highest bidder that he has won; however, he only has to pay the second highest bid price. This type of auction allows buyers to bid the “true value” of an item, i.e., the value of an item is worth what someone is willing to pay for it.

In a uniform second price auction, the auction operates similar to a Vickrey auction except there are multiple units of an item to be sold rather than one item. All buyers' bids are submitted in confidence with the amount they are willing to pay as well as the quantity of the item wanted. Once the auction closes, the buyer with the highest bid gets the quantity he requested. The auctioneer then goes to the next highest bid wherein that buyer gets the amount he requested, and so forth until there are no more units. The winning buyers will all pay the price of the lowest winning bid.

These known auctions fail to create a true market where items up for bid are sold at a price that is not only what the seller wants, but what the buyer is willing to pay. Therefore, there is a need for an auction system for the creation of an online marketplace for the sale and purchase of goods and services where the benefits of a true supply and demand model can be realized.

### SUMMARY OF THE INVENTION

In one aspect of the invention a computer implemented continuous dual auction system may include a server to house all of the databases available for the different types of items being sold and/or offered for sale. The system may also include a website that allows the interaction between different users in the sale and purchasing of items and a process for the selling and buying of items. The computer implemented continuous dual auction system may provide a way for the user to either buy or sell goods or services in a real-time online marketplace. In another aspect of the invention, the computer implemented continuous dual auction system may also provide additional security because of its guaranty and authorization system before a user can buy or sell items on the online marketplace.

In another aspect of the invention, the computer implemented continuous dual auction system may provide the ability for the users to enter proxy bids and offers that are hidden from the other users of the real-time auction market. One aspect of the proxy system may be that it allows for a sale or purchase to happen within set price parameters setup by a user. Another aspect of the proxy system may be that it allows the user to step away from the market without risking missing another's matching bid or offer. The proxy system may allow for the sale or purchase to happen at a price the user specifies without the user being constantly logged on and actively watching the marketplace. One benefit of this proxy system may be that the user can be doing other things and still having an active order in the marketplace. Another benefit may be that the user is able to transact with another user within their set parameters while away from the marketplace.

In another aspect of the invention, a real-time online marketplace may be provided wherein both the buyer and seller can see other bids and offers, as well as their own. Both buyers and sellers may be able to “show their hand” to the marketplace and try to entice the counterparty to raise their bid or lower their offer. A further aspect of the invention may include the online marketplace being continuous, wherein an auction is open as long as there is a bid or offer for a certain good or service. In this embodiment, when a buyer and seller transact, it may be that only that buyer and that seller are removed from the marketplace as they have fulfilled their sale or purchase. All other buyers and sellers may remain in the marketplace.

In another aspect of the computer implemented continuous dual auction system, there various real-time online marketplaces may be created within the host website. For example, one database may be for the sale of concert tickets, one database may be for the sale of goods such as used furniture or electronics, and yet another database may be for the sale of services such as carpet cleaning. Because some of these items may have a time limit attached to them, for example the sale of event tickets, such marketplaces may have an end time that matches the start time of the event ticket. For example, the continuous dual auction marketplace for the sale of certain theatre tickets may close at a certain time that is the same as the starting time of the theatre performance. Another aspect of the various continuous dual auction system marketplaces may be the ability to support the sale and purchase of both paper tickets as well as electronic tickets to events like a football game.

The computer implemented continuous dual auction system may create a true supply and demand online marketplace. By combining several buyers competing for the goods or services of several sellers, the online marketplace may dictate the price. A further advantage may include, for example, if a buyer likes a seller's price, the buyer can buy it at that price. And vice versa, if a seller likes the buyer's price, the seller may be able to sell their product or service at that buyer's price. In other known online marketplaces, it is far more likely that either the seller dictates the price or the buyer dictates a price. A buyer dictated or seller dictated price may be characterized as unfair marketplace because the true “price” of a good or service may not be discovered. By allowing all buyers and sellers to compete against one another in a real-time online marketplace, a true price may be discovered and both buyer and seller are satisfied.

The above summary of the various aspects of the invention is not intended to describe each embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

These as well as other objects and advantages of this invention will be more completely understood and appreciated by referring to the following more detailed description of the exemplary embodiments of the invention in conjunction with the accompanying drawings of which:

FIG. 1 is an illustration of a sample login site.

FIG. 2 is an illustration of a seller's montage.

FIG. 3 is an illustration of seller's flowchart.

FIG. 4 is an illustration of entering new or saved credit card information.

FIG. 5 is an illustration of a buyer's montage.

FIG. 6 is an illustration of a buyer's flowchart.

FIG. 7 is an illustration of the continuous dual auction system's seller montage.

FIG. 8 is an illustration of the continuous dual auction system's buyer montage.

FIG. 9 is an illustration of a proxy bid.

FIG. 10 is an illustration of a proxy offer.

FIG. 11 is an illustration of a guaranty flowchart.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives.

### DETAILED DESCRIPTION OF THE PREFERRED EMBODIMENTS

The several embodiments as shown in the figures may allow the user of the computer implemented continuous dual auction system to have multiple choices, as there are several choices relating to the many online marketplaces available. Advantages and embodiments of this invention are further illustrated by the following examples, but the particular materials and amounts thereof recited in these examples, as well as other conditions and details, should not be construed to unduly limit this invention.

A user may use a personal computer, a personal digital assistant (PDA), or other internet capable device to take part in the online marketplace for the sale or purchase of goods and services, for example the purchase of event tickets. Upon entering the computer implemented continuous dual auction system, an individual may log into the system by setting up a username and password. The user may then have the ability to search the site for a certain good or service, like an event ticket, post a bid to buy a good or service, or post an offer to sell a good or service. If the user would like to post a bid, the user may be prompted to enter credit card information into the system to guaranty the buyer's ability to pay for the purchase of the item. Similarly, if the user would like to post an offer, credit card information may be entered into the system to guaranty the seller is actually selling an item. This credit card information may also fund a guaranty in case the seller defaults in transferring or sending the item to the buyer, as well as guaranteeing that the sold item is actually sent to the buyer. The credit card information may be saved into the system for the user's convenience in using the computer implemented continuous dual auction system at a later time.

If a seller would like to sell an item, for example, event tickets, the seller may click on a seller's toolbox, for instance, located on the continuous dual auction system's website and enter the information regarding what type of event ticket is being sold as well as the offer price and proxy offer price. If a seller may not want to enter a proxy offer price or may forget to enter a proxy offer price, the system may automatically update the proxy offer price with the amount entered for the offer price. A seller may also enter whether the event ticket is an electronic ticket or a paper ticket. Such information may determine when the auction closes for such seller due to the time limit of mailing a paper ticket versus electronically emailing an electronic ticket. If a buyer would like to buy an item, for example event tickets, the buyer may click on the buyer's toolbox, for instance, located on the continuous dual auction system's website. The buyer may enter the information regarding what type of event ticket is being sought, as well as the bid price and proxy bid price for that event ticket. If a buyer may not want to enter a proxy bid price or may forget to enter a proxy bid price, the system may automatically update the proxy bid price with the amount entered for the bid price.

If, for example, the event ticket is a paper ticket, that seller's offer may be removed from the system at least forty-eight hours before the event so that the seller has enough time to send the tickets, for example via overnight delivery, to the buyer. However, if the event ticket is an electronic ticket, that seller's offer may remain posted up to at least one (1) minute before event time, as these tickets may be sent electronically and the buyer may receive them immediately. While an auction for other goods and services may remain open indefinitely, an auction for other items, for example event tickets, may close completely at least one (1) minute before event time and no other bids or offers may be able to post or transact for that particular event or item.

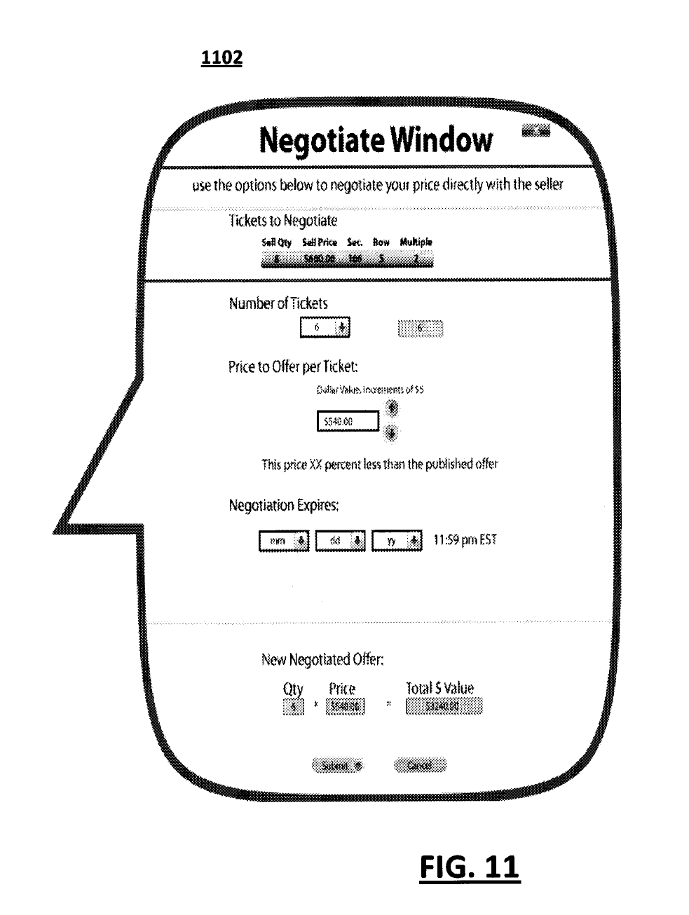

After event ticket information has been entered by the user, a real-time dual auction system database webpage may appear in which the user can see all other bids and offers relating to that specific event. At anytime, a user may instigate negotiations, as discussed in more detail in FIG. 11, between another user regarding the sale and/or purchase of a specific item, for instance a good, service or event ticket or tickets. If said negotiations are successful, a sale may be said to be completed. The buyer's credit card may be debited for the amount of the purchase price of the event tickets plus any auction fees relating to such sale by the system. The system may then credit the seller's account with the funds from the sale less any fees associated with the sale of the event ticket. Once the sale is completed, the seller may transfer either electronically or via overnight delivery, for example, the event ticket to the buyer. If negotiations do not result in a sale, the event tickets may remain in the real-time auction system database and both the buyer and seller may return to the real-time auction system database webpage.

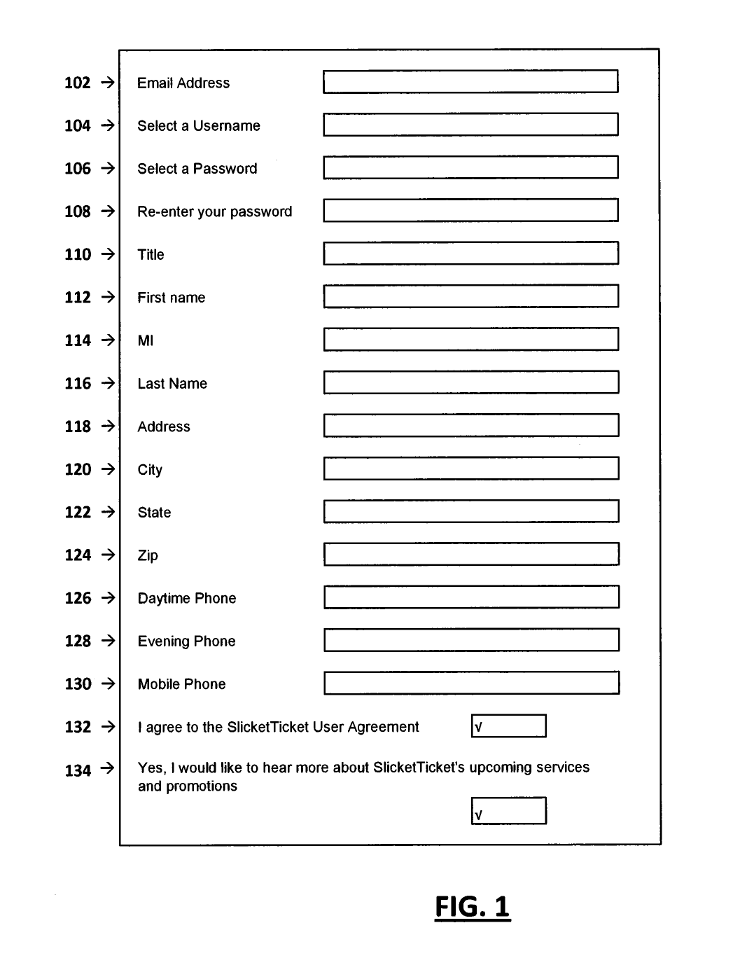

FIG. 1 is an illustrative montage of the continuous dual auction system's login and profile page. As shown, the user may have to enter a valid email address 102, create a username 104 and password 106. To verify the password, the user may have to re-enter the password 108. The user may also be required to enter certain other personal information such as the user's title 110, first name 112, middle name or initial 114, last name 116, street address 118, city 120, state 122, zip code 124, daytime phone number 126, evening phone number 128, and mobile phone number 130. A user may enter this information in any number of ways. For example, a user may enter the user's title 110 by either typing in the information, choosing a title from a drop down box, or any other way to designate a title. A user may also be able enter address information such as a city 120 by typing in the name of the city, choosing a city from a drop down box, or any combination or other way of entering a city. Similarly, user may enter the state 122 by typing in the name, choosing the state from a drop down box, any combination or other way of entering a state. A user may enter a phone number by either typing the number in by a designated format, or there may be three boxes one for the area code, prefix and suffix of the number, or any combination thereof. These are only examples of how such information may be entered. Other approaches to entering the data may also be used.

A user may then be required to choose either to agree with the user license agreement or not 132. There may be a clickable link that will take the user to view and read the license agreement before continuing into the system. If the user enters a yes, by either typing in the word or choosing it from a drop down box, or some other way to signify acceptance of the license agreement, then the user may continue in its use of the system. If the user declines to accept the terms of the user license agreement by either entering no or choosing no from a drop down box or otherwise signifying non-acceptance of the license agreement, the user may not be able to continue with its use of the system.

A user may then also be able to agree to receive information regarding upcoming events and promotions 134. A user may signify acceptance or non-acceptance of future information by either typing in yes or no, choosing one from a drop down box, or otherwise signifying the same.

A user may wish only to search the system's database for different events. They may access different auctions by searching for a certain event and then have the ability to choose to log in and/or setup a log in, post a bid, or enter an offer. If the user wishes to enter a bid for an item, like an event ticket, the user may need to enter a valid credit card before being able to post a bid, as explained in more detail below. In setting up the user profile, a user may be able to indicate whether the user would like an email notice or alert to be sent if an offer or bid is within a certain percentage of their bid or offer.

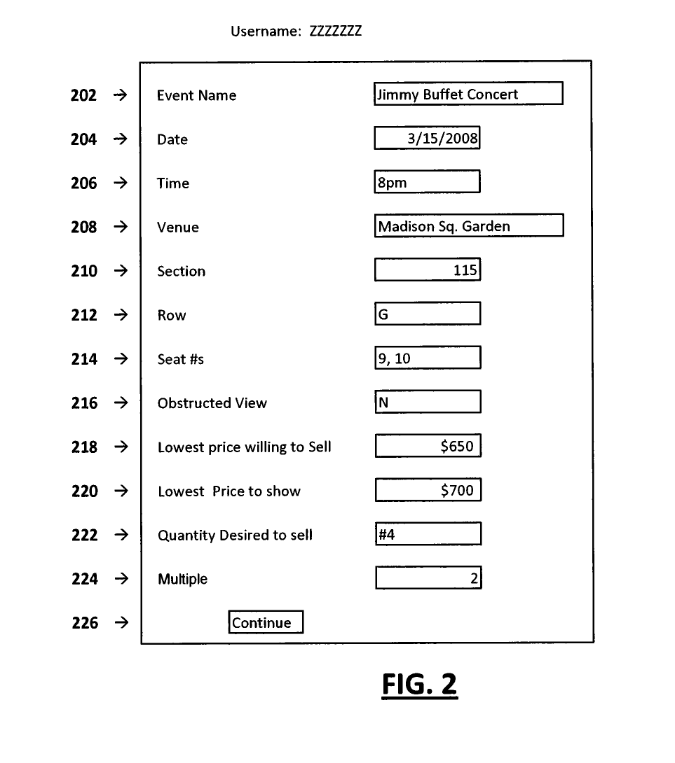

FIG. 2 is an illustration of a seller's montage. Before or after logging into the auction database system, a seller wishing to sell, for example, an event ticket or tickets may enter an offer to sell such event ticket or tickets by accessing the seller's toolbox in the auction system's database. A seller may then click on a button, for example a button entitled “Post Offer.” A dialog box may open and prompt the seller to enter the event name 202, date of the event 204, time of the event 206, venue of the event 208, section where the event tickets are located 210, what row in that section 212, the seats in that section 214, and whether the seats have an obstructed view or not 216. A seller may enter the event name 202, venue of the event 208 and the section 210 in a number of ways. For instance, the seller may type in the name, venue and section; the seller may have a drop down box in which to pick the event, venue, and/or section; the seller may be able to click on a link to search for any one of the name, venue and/or section. Said link may pull up a map of the venue in which the seller may be able to click within a certain section of the venue map and these entries will be automatically populated with this information. The seller may be able to enter this in any number of other ways including any combination of the above. Depending on the item being sold, a user may be required to enter some of this information or some of the information may be optional. What information a user may enter may be dependent on what is being sold by the user, wherein additional or different information may be required or optional for the user to enter.

A seller may be able to enter the row 212 and seat 214 in a number of ways. The seller may be able to type these in, there may be a drop down box with this information, or any combination or other form of entering in this information may be possible. A seller may be able to enter whether the seats have an obstructed view or not 216 in a number of ways. The seller may be able to type in the words “yes” or “no,” the seller may be able to type “y” for yes or “n” for no, the seller may be able to pick yes or no from a drop down, or any combination or other form in which the seller may be able to designate if there is an obstructed view or not.

The seller may also input the lowest price it is willing to sell the event tickets a/k/a the proxy offer 218, the lowest price to be shown in the auction system's database a/k/a the offer 220, the quantity of tickets being sold 222, and in what multiple the tickets may be sold if the seller has more than one 224. The seller may be able to input the proxy offer 218 and offer 220 in any number of ways. The seller may be able to type in the amount, there may be a drop down box containing different amounts the seller may select from, or any combination or other way for the seller to input the amount of the proxy offer 218 and the offer 220. The seller may be able to input the quantity of tickets 222 and the multiple 224 in any number of ways. For example, the seller may be able to type in the quantity and multiple, the seller may be able to choose a certain quantity or multiple for a drop down box, or any combination of these or other way in which the seller can input the quantity 222 and the multiple 224 into the system.

The seller may click a button, for example, a “Continue” button 226, and another dialog box may open for the user to either log into the system if the user has not done so already or enter credit card information. If the seller chooses to enter credit card information, another dialog box opens up in which the seller may either choose a saved credit card or enter a new or different credit card to proceed with the transaction.

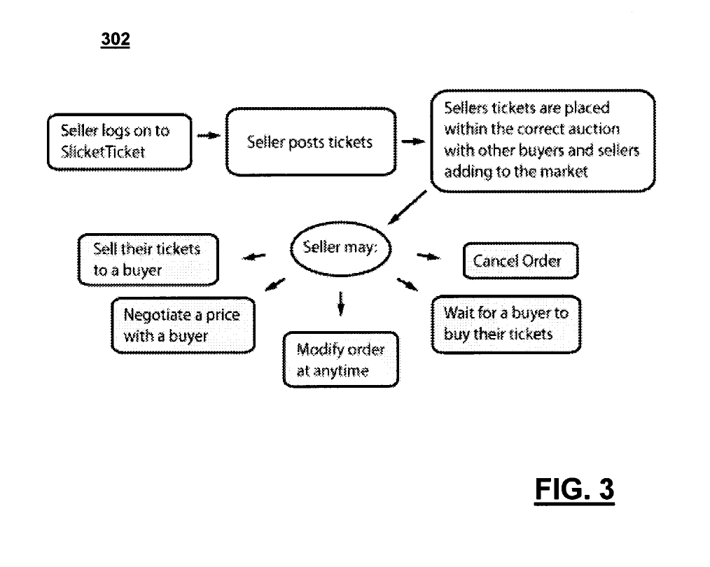

FIG. 3 is an illustration of a seller's flowchart. The flowchart 302 illustrates how a seller may proceed through the auction system. For instance, the seller may log into the system, post an offer, which is populated into the corresponding auction system database. For example, afterwards the seller may do any of the following: cancel the order, modify the amount of the offer, wait for buyers to buy the seller's item, negotiate a price with a buyer, and/or sell the item to a buyer. A seller may also search an event first before logging in and/or posting an offer. A seller may also enter the system's website to post an offer, wherein the seller may log into the system after inputting information related to the item being sold. There are multiple ways in which a seller may proceed through the auction system and this figure and details are non-limiting.

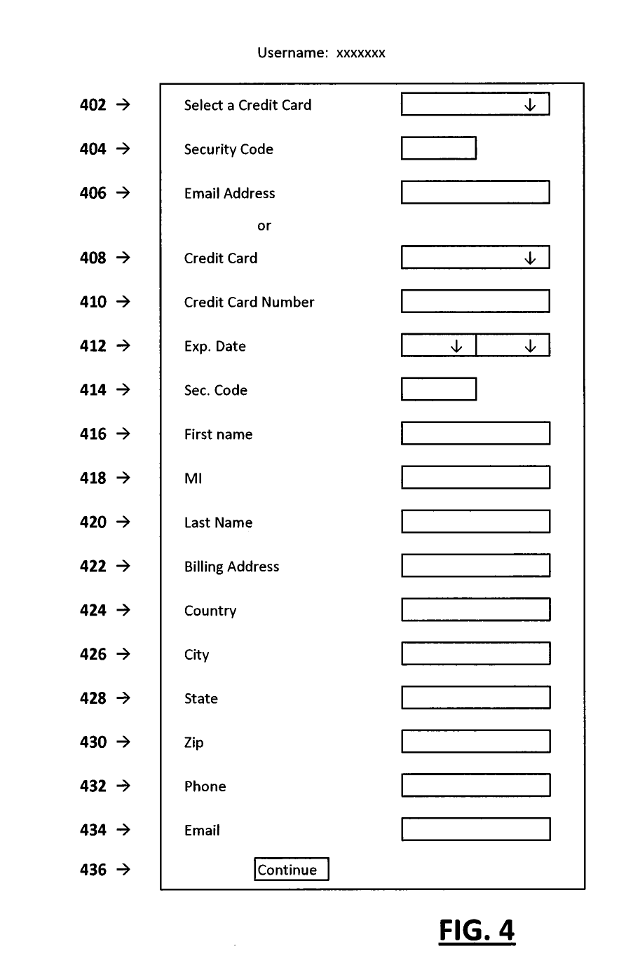

FIG. 4 is an illustration of the dialog box in which a seller or buyer may instruct the auction system to either use the credit card information already stored in the system or to enter new credit card information into the system. If a seller or buyer has multiple credit cards on file, at the top of the dialog box the buyer or seller may be able to choose which credit card it would like to use, for example, from a drop down box 402. The seller or buyer may have to enter the security code 404 associated with the chosen credit card, and the buyer's or seller's email address 406 may be entered for verification purposes, email notices or alerts, promotional emails, and any other reason an email address may be used. The buyer or seller may enter this information in a number of ways. For example, there may be a drop down box in which the saved credit cards have been saved, the buyer or seller may type in this information, or any combination of these.

If the buyer or seller would like to either use a different card for the transaction or needs to enter a credit card for the first time, they may input additional information. The buyer or seller may input the type of credit card 408, the credit card number 410, the expiration of the credit card 412, the security code for the credit card 414, the first name shown on the credit card 416, the middle initial or name shown if shown on the card 418, the last name shown on the credit card 320, the billing street address 422, country 424, city 426, state 428, zip code 430, phone number 432 and email address 434. Some information that a buyer or seller may input may be required and some information may be optional. After the buyer or seller inputs this information they may click on a button to continue, such as a button labeled “Continue,” 436, wherein another dialog box may ask whether the buyer or seller would like to save this information in the system. If the buyer or seller wishes to save the credit card, they may be asked to name the card for later recognition. If not, the credit card information may remain in the system for the duration of the auction it is registered with. If the buyer or seller completes a sale, this credit card may be used. If the buyer or seller does not complete a sale by the time the auction ends, the credit card information may be deleted from the system as may all other unfilled bids or offers when the auction closes.

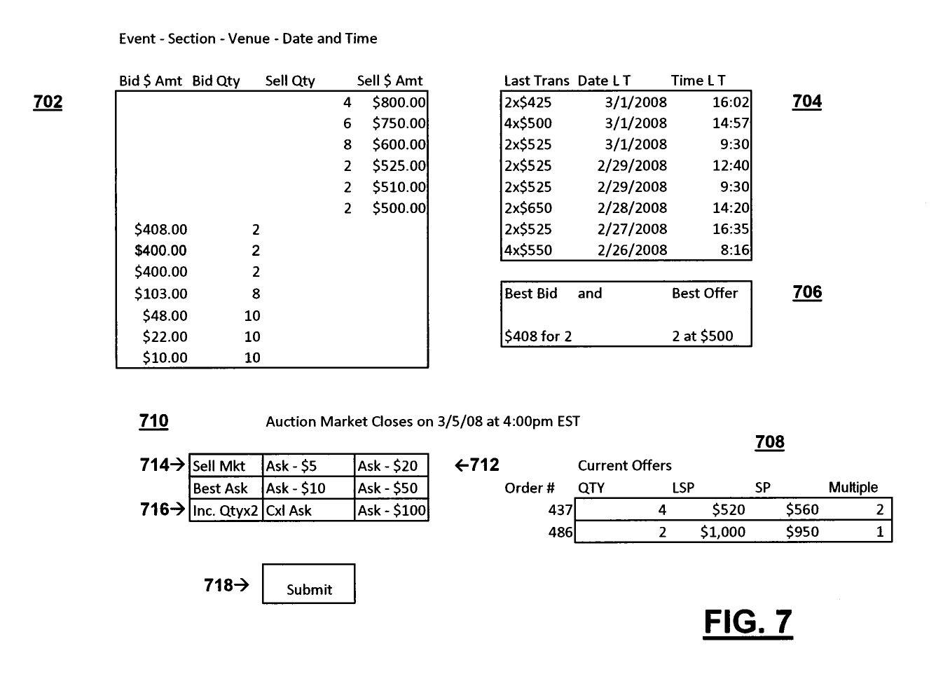

After the credit card information is entered into the system and confirmed, the auction database system may upload the event ticket information being sold into the related event-specific real-time auction system database, as discussed in more detail below with respect to FIG. 7. The seller may be brought into the online auction marketplace and may be able to see all other bids and offers relating to the specific event.

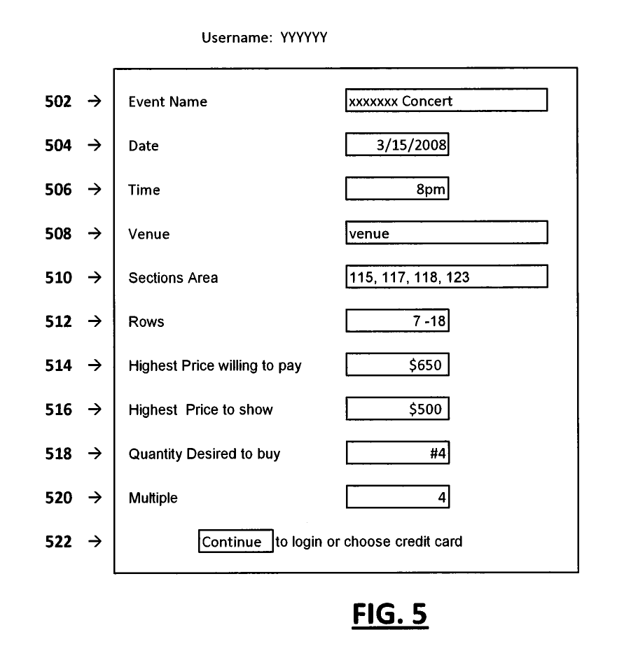

FIG. 5 is an illustration of a buyer's montage. After logging into the auction system, a buyer wishing to buy, for example, an event ticket or tickets may enter a bid to buy such event ticket or tickets by accessing, for instance, a buyer's toolbox in the auction system. The buyer may click on a button, for example, a button entitled “Enter Bid,” wherein a new dialog box may open. The dialog box may prompt the buyer to enter the event name 502, date of the event 504, time of the event 506, the venue of the event 508, the section of the seats desired 510, and the rows desired. When inserting the date of the event 504, the buyer may input the date in any of the following ways: the buyer may type it in a certain format like mm/dd/year; perhaps the buyer will select the month, day and year from three separate drop down boxes; there may be a calendar button next to the entry box in which the buyer may click on the button and a calendar dialog box may open and the buyer may click on the appropriate date, which may then be automatically filled into the entry space; or any other way to enter the date or combination thereof. Further, when a buyer enters the time of the event 506 the buyer may enter this time in a number of ways. For instance, any of the following may be implemented by the buyer: there may be three drop down boxes for the hour, minute and whether am or pm; there may be one drop down box; the buyer may be able to input the time in a specified format; there may be a button in which the buyer may click on wherein a clock appears and the buyer can click and the time may automatically be filled into the entry space; or any combination of these or other method available to input this information. These ways are just some of the ways a time and date may be entered. Other time and date entry processes may also be used.

When a buyer is entering the venue of the event 508, as well as the section 510, the buyer may enter this information in a number of ways. The buyer may type in the name of the venue and the section desired or there may be a drop down box for either or both of these fields. Additionally, there may be a link next to the entry box in which to determine what venue the event is at. Such link may allow the user to search for the event by name and may provide the buyer with the name of the venue. The system may also provide a map of the venue, wherein the buyer may be able to click in a certain section, level, etc of the map and the venue name and section may be automatically populated with this information.

The buyer may also input the highest price at which it is willing to buy the event tickets a/k/a the proxy bid 514, the highest price to be shown in the auction database a/k/a the bid 516, the quantity of tickets being sought 518, and in what multiple 520 they would like to buy tickets if they are looking to buy more than one. The buyer may enter the proxy bid 514 and bid 516 may be entered in a variety of ways. For example, there may be a drop down box with certain dollar amounts listed, there could be a multiple of drop down boxes, or the buyer could type in the amount, etc. The buyer may also enter the quantity 518 and multiple 520 in a variety of ways. For instance, there may be a drop down box including certain numbers like 1 through 10 or other numbers, the buyer may be able to type in the number, or other similar way.

After all information is entered into the dialog box by the buyer, the buyer may then click a button to proceed, for example, “Continue” 522 and another dialog box may open for the user to either choose to log in to the system if they have not already done so or to enter credit card information. If they have already logged in and chose to enter credit card information, another dialog box may open and ask the buyer if they would like to use a saved credit card or enter a new or different credit card to proceed with the transaction, as further described above in FIG. 4. The auction system may upload the event ticket information being sought into the related event-specific auction database. The buyer may be brought into the online real-time auction marketplace and may see all other bids and offers relating to the specific event.

A buyer and seller may also have the ability to submit multiple bids or offers across different levels or sections of a particular venue for a particular event. Because, for example, most stadiums, theatres, etc. are broken down into “areas,” like sections or levels, a buyer or seller can post a bid or offer based on the different areas available for each event. When entering a bid or offer, a buyer or seller may search for a particular event. When the auction system links the buyer and seller with the event venue, a map of the venue, for example a color-coded by section of a football stadium, may be pictured on the webpage. The buyer and seller may then click in an area of the map, for instance the lower level and middle section of the stadium or click on a text description of the venue map. After clicking in that area or text description, a dialog box may open up and ask the user if they would like to post a bid or enter an offer related to that specific location of a certain event. This allows a buyer to bid on multiple areas of a stadium without risking overbuying. A buyer may enter as many bids as a buyer may wish; however, as soon as a sale is completed for the purchase using one of the several bids posted all other remaining bids may be canceled. The system may also allow users to “group” their bids, meaning that if they buy tickets they can dictate which bids they would still like to remain active and which bids should be canceled.

Once a bid is entered, the buyer may be prompted with a dialog box asking to confirm or deny that this bid should be canceled upon another bids execution. If the buyer confirms and one of their other bids is executed, then this bid may be canceled and removed from the real-time auction database system. If the buyer denies and one of their other bids is executed, then this bid may remain active in the real-time auction database system, wherein the buyer can purchase additional event tickets to the specified event. The system may allow the buyer full functionality to cancel and/or modify bids at anytime.

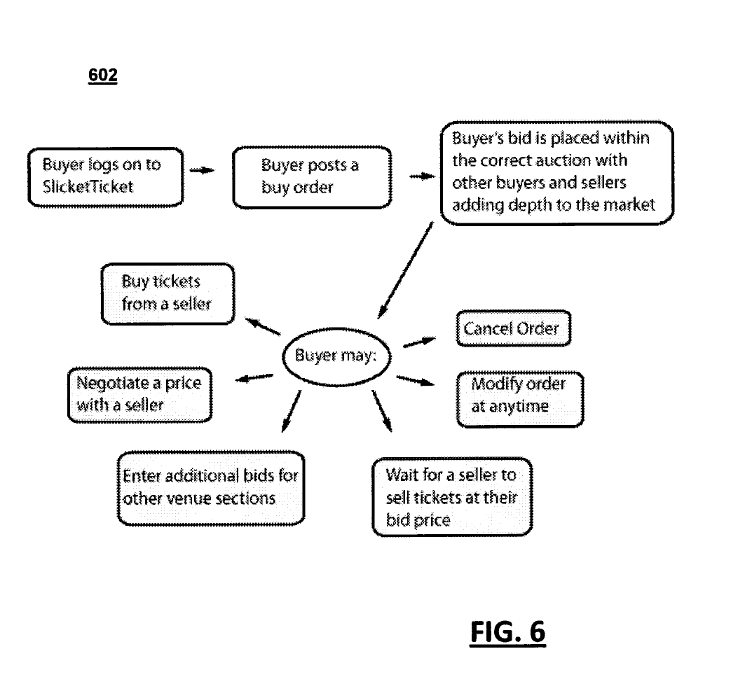

FIG. 6 is an illustration of a buyer's flowchart. The buyer's flowchart 602 illustrates how a buyer may proceed through the auction system. For instance, the buyer may log into the system, post a bid, which is populated into the corresponding auction system database. For example, afterwards the buyer may do any of the following: cancel the order, modify the amount of the bid, wait for sellers, negotiate a price with a seller, and/or buy the item from a seller. A buyer may also search an event first before logging in and/or posting a bid. A buyer may also enter the system's website to post a bid, wherein the buyer may log into the system after inputting information related to the item being sought. There are multiple ways in which a buyer may proceed through the auction system and this figure and details are non-limiting.

FIG. 7 is an illustration of the continuous dual auction system's seller montage. The seller may be directed to a real-time online auction database system webpage showing the current bids database 702, the most recent transactions database 704, and the current best bid and offer database 706, and current offers database 708. Also shown is the seller's toolbox 710, which may allow the seller to modify the posted offer by a certain dollar amount or choose to sell the tickets at the current market price listed in the real-time auction database 702. A seller may have the option to modify the posted offer at anytime by a certain dollar amount by clicking a button, for example the “Ask—$20” button 512, wherein the seller's posted offer amount may be automatically modified by the amount specified on the button. For example, the button “Ask—$20” may decrease the seller's posted offer by twenty dollars ($20). A seller wishing to sell tickets before their offer is matched to a bid may have to sell at the market price, which may be defined as the current highest price a buyer is willing to pay for the tickets. To effect a market sale, the seller may click on a button indicating a market sale, for example, the “Sell Mkt” button 714 in the seller's toolbox 710. The quantity field 716 will expand and may be automatically populated with the quantity of tickets the buyer is willing to purchase at that price. The seller may effect the transaction by clicking on a button, for example, on the “Submit” button 720. The buyer's bid may be removed from the real-time auction database 702 and the latest transactions database 704 may be updated with this transaction. After the seller clicks on the Submit button 720, another dialog box may open to verify that the seller wishes to proceed with this transaction. This may protect against the seller inadvertently effecting a sale such as by accidentally clicking on the Submit button 720.

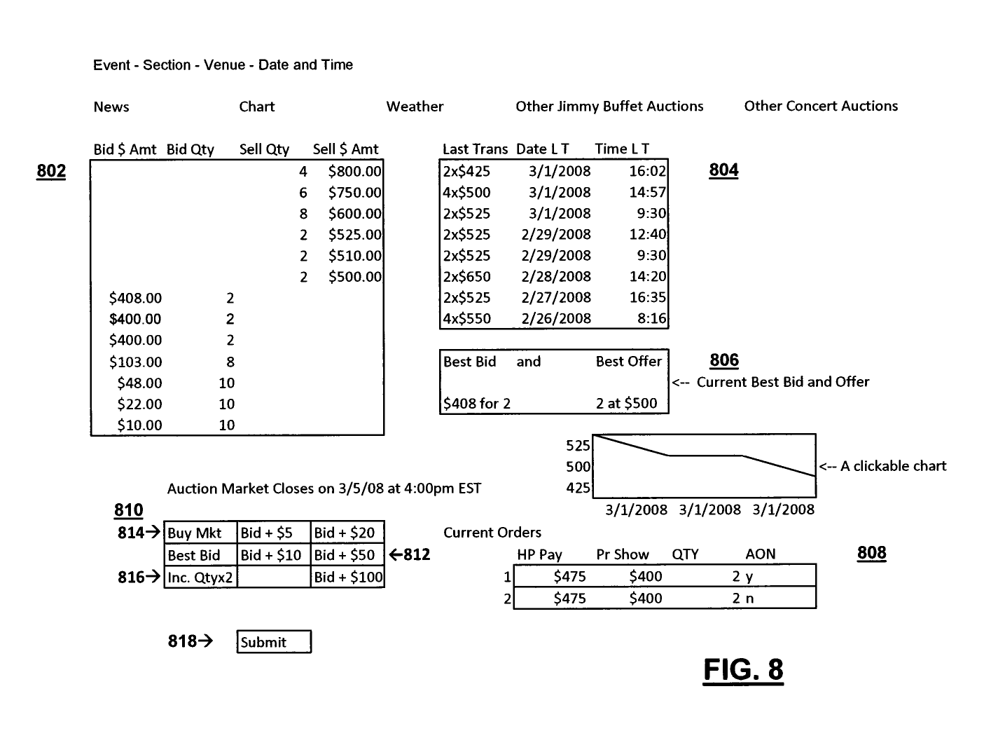

FIG. 8 is an illustration of the continuous dual auction database system's buyer montage. The buyer may be directed to a real-time auction database webpage showing the current bids database 802, the most recent transactions database 804, the current best bid and offer database 806, and current offers database 808. Also shown is the buyer's toolbox 810, which may allow the buyer to increase or decrease the buyer's posted buying price by a predetermined amount by, for example, clicking on a button entitled “Bid+$5” button 812, wherein the bid will increase by $5 in the current bids database 802. A buyer may also buy event tickets at the current market price. If the buyer wishes to buy event tickets without having to wait for their bid to be matched with a seller's offer, they can buy the tickets at the market price, which may be defined as the lowest posted offer a seller is willing to sell the event tickets for. The buyer can click on a button, for example the “Buy Mkt” button 814, wherein the quantity field 816 is expanded and the buyer can enter the number of event tickets desired. A buyer may not have to purchase all tickets a seller may have available for sale; however, in some embodiments, they may be required to purchase in a multiple the seller is asking for. After entry of the quantity, the buyer may then click on a button to proceed or submit the quantity, for example the “Submit” button 618 to finalize the purchase of the event tickets. This may provide a checking mechanism in case the buyer accidentally presses the “Buy Mkt” button 814. The tickets purchased may then be removed from the real-time auction database 802. The latest transaction database 804 may then be updated with the most recent sale.

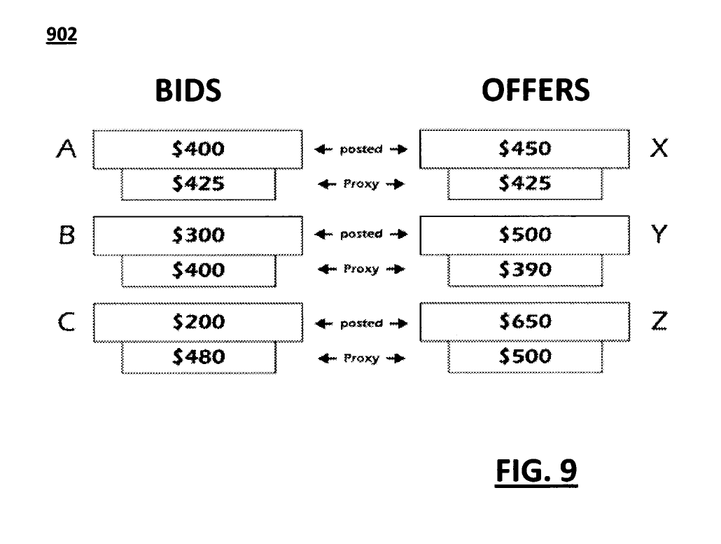

FIG. 9 is an illustration of a proxy bid. The proxy bid diagram 902 may reflect a transaction wherein a proxy bid is more than a posted offer. For example, buyer C in the diagram 902 may complete a transaction with seller X because buyer C's proxy bid is more than seller X's posted offer. Where a transaction may match a buyer and a seller together because of a proxy bid, the buyer may or may not decide to effect this transaction. Another possibility is to have these types of transactions automatically effect a sale between a buyer's proxy bid and a seller's posted offer. This may be an instance where an email notice or alert has been setup to notify the buyer that the buyer's proxy bid has matched up with a seller's posted offer. If a sale is effected, both bid and offer may be removed from an auction's real-time auction database and the corresponding auction latest transaction database may be updated with the sale. This can also happen when a new seller enters the real-time online auction marketplace and enters an offer that matches a buyer's proxy offer.

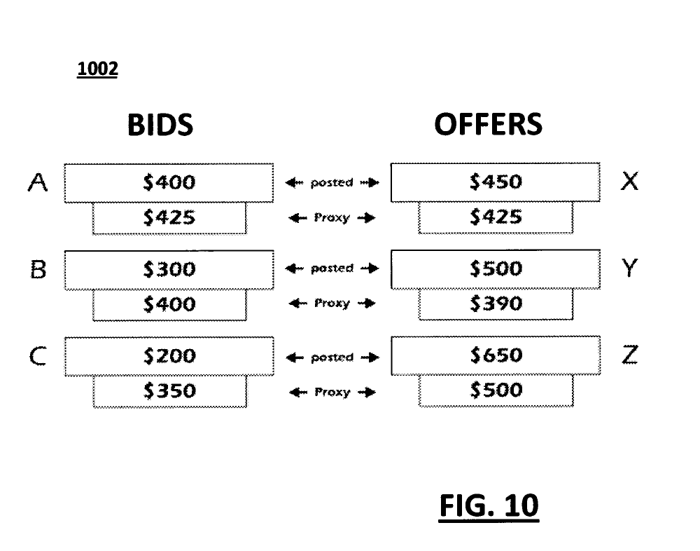

FIG. 10 is an illustration of a proxy offer. The proxy offer diagram 1002 may reflect a transaction wherein a proxy offer is less than a posted bid. For example, seller Y in the diagram 1002 may complete a transaction with buyer A because seller Y's proxy offer is less than buyer A's posted bid. Where a transaction may match a seller and a buyer together because of a proxy offer, a seller may or may not decide to effect this transaction. Another possibility is to have these types of transactions automatically effect a sale between a seller's proxy offer and a buyer's posted bid. This may be an instance where an email notice or alert has been setup to notify a seller that a buyer's post bid has matched up with a seller's proxy offer. If a sale is effected, both bid and offer may be removed from an auction's real-time auction database and the corresponding auction latest transaction database may be updated with the sale. This can also happen when a new buyer enters the real-time online auction marketplace and enters a bid that matches a seller's proxy offer.

A sale may also be effected where a buyer's posted bid and a seller's posted offer are the same. There may be other variants on how a buyer and a seller may effect a transaction, such as negotiating, which effects a sale.

FIG. 11 is an illustration of a negotiation dialog box. If a seller or a buyer choose to enter into negotiations with a buyer or a seller, respectively, they may do so by clicking on a negotiate button, for example “Begin Negotiations” that may be in a seller or buyer toolbox, or it may be on the auction system database webpage, or some other configuration, like a link or option from a drop down menu box. If a buyer, for instances, clicks on the negotiation button, a negotiation dialog box 1102 may appear. The dialog box 1102 may contain such information as the item being negotiated, the number of the items, the price, when the negotiation is set to expire and the new negotiated offer. The dialog box 1102 may contain any of the foregoing things, some of them, any combination, and/or the addition of other information.

The input of a credit card information may fund a guaranty that a seller will complete a transaction after a sale has been effected by transferring or sending the item to a buyer. This may be of the form in which after a sale is effected, the buyer's credit card is debited for the amount of the purchase plus any fees. This amount may be placed into an escrow account for at least forty-eight (48) hours until confirmation of the item is received. This time may be increased or decreased depending on the type of item being purchased or sold. When a seller is notified of an effected sale, the seller may be able to print, for example, a Fedex label to ship the item with. The seller's credit card may be authorized for twice the amount of the sale price in case the seller defaults in transferring or sending the item, or in case the seller may not have the item to sell. If a seller does default on a sale, the buyer may be credited with twice the sale price, which sum may be obtained from the seller's credit card. The escrowed sale amount may be kept by the system for operating costs associated with the transaction. The defaulting seller may be banned and/or reported for fraud. There are many ways in which the auction system may fund a guaranty for the possibility of a defaulting seller and/or buyer.

The preceding description has been presented only to illustrate and describe exemplary embodiments of invention. It is not intended to be exhaustive or to limit the invention to any precise form disclosed. Many modifications and variations are possible in light of the above teaching. Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

What is claimed is:

1. A computer readable storage medium encoded with processing instructions for implementing a continuous dual auction system comprising,
creating auction databases within the continuous dual auction system for various items;
receiving electronically from multiple buyers bids for a purchase of an item;
receiving electronically from multiple sellers offers for a sale of an item;
receiving electronically a buyer's credit card information;
receiving electronically a seller's credit card information;
posting multiple bids for a purchase of an item within an auction database;
posting multiple offers for a sale of an item within an auction database;
effecting a sale between a buyer and a seller for an item;
updating the auction system with a sale's transaction;
removing a buyer's bid from the database; and
removing a seller's offer from the database.

2. The system of claim 1, further comprising a buyer's ability to negotiate with a seller for the purchase of an item, wherein completion of the negotiation for the sale of the item effects a sale, wherein the buyer's bid and the seller's offer are removed from the auction system's database.

3. The system of claim 1, further comprising a seller's ability to negotiate with a buyer for the sale of an item, wherein completion of the negotiation for the sale of the item effects a sale, wherein the buyer's bid and the seller's offer are removed from the auction system's database.

4. The system of claim 1, wherein an auction for a particular item opens after a database is created within the auction system for that particular item.

5. The system of claim 1, wherein the auction for a specific item closes when there are no bids or offers posted within the auction database.

6. The system of claim 1, wherein an event ticket auction closes at least one (1) minute before the start of the event if the event ticket is electronic.

7. The system of claim 1, wherein a bid can be removed or modified at any time during an auction, unless the bid has effected a sale.

8. The system of claim 1, wherein an offer can be removed or modified at any time during an auction, unless the offer has effected a sale.

9. The system of claim 1, further comprising a buyer's ability to post more than one bid.

10. The system of claim 1, further comprising a buyer's ability to use a proxy bid to effect a sale with a seller.

11. The system of claim 1, further comprising a seller's ability to use a proxy offer to effect a sale with a buyer.

12. A computer readable storage medium encoded with processing instructions for implementing a continuous dual auction system comprising,
creating auction databases within the continuous dual auction system for event tickets;
receiving electronically from multiple buyers bids for a purchase of the event tickets;
receiving electronically from multiple sellers offers for a sale of the event tickets;
receiving electronically a buyer's credit card information;
receiving electronically a seller's credit card information;
posting multiple bids for a purchase of the event tickets within an event ticket auction database;
posting multiple offers for a sale of an event ticket within an event ticket auction database;
effecting a sale between a buyer and a seller for an event ticket;
updating the event ticket auction database with a sale's transaction;
removing a buyer's bid from the auction database; and
removing a seller's offer from the auction database.

13. The system of claim 12, wherein an event ticket auction closes at least forty-eight (48) hours before the start of the event if the event ticket is a paper ticket.

14. The system of claim 12, wherein an event ticket auction closes at least one (1) minute before the start of the event if the event ticket is electronic.

15. The system of claim 12, wherein a bid can be removed from the auction at any time before it is accepted.

16. The system of claim 12, wherein an offer can be removed from the auction at any time before it is accepted or sold.

17. The system of claim 12, wherein a buyer can place multiple bids for the same or different events.

18. The system of claim 12, wherein a buyer's acceptance of an offer will cancel all other bids for that same event, unless said buyer indicates otherwise.

19. The system of claim 12, wherein a seller can place multiple offers for the same or multiple events.
